(19) United States
(12) Patent Application Publication
(10) Pub. No.: US 2010/0091710 A1
(43) Pub. Date: Apr. 15, 2010

(54) METHOD OF PROVIDING IP MOBILITY USING SCTP SIGNALING IN 3GPP BASED NEXT GENERATION MOBILE COMMUNICATION NETWORK

(75) Inventors: Hee Young Jung, Daejeon (KR); Hyun Seo Park, Daejeon (KR); Boo Geum Jung, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/535,125

(22) Filed: Aug. 4, 2009

(30) Foreign Application Priority Data
Oct. 9, 2008 (KR) 10-2008-0099300

(51) Int. Cl. H04W 8/08

(52) U.S. Cl. 370/328

(57) ABSTRACT

Provided is a method of providing IP mobility using SCTP (Stream Control Transmission Protocol) signaling in a 3GPP (3^{rd} Generation Partnership Project) based next generation mobile communication network. The method of providing IP mobility constructs an IP mobility protocol on an SCTP layer of an interface protocol used between an integrated gateway supporting binding a mobile terminal with a different type network and at least one base station and used between base stations, generates a signaling message for binding the mobile terminal with the network according to the IP mobility protocol, embeds at least a part of the signaling message in the SCTP layer to generate an SCTP packet and transmits the SCTP packet to update binding of the mobile terminal and the network. Accordingly, design and construction of network related equipment and mobile terminal for obtaining IP mobility in the mobile terminal and the network can be efficiently performed and unnecessary overhead can be prevented.

### CROSS-REFERENCE TO RELATED APPLICATION

This application claims the benefit of Korean Application No. 10-2008-0099300, filed on Oct. 9, 2008 in the Korean Intellectual Property Office, the disclosure of which is incorporated herein by reference.

### BACKGROUND OF THE INVENTION

1. Field of the Invention

The present invention relates to a method of providing IP mobility using SCTP (Stream Control Transmission Protocol) signaling in a 3GPP (3^{rd} Generation Partnership Project) based next generation mobile communication network, and more particularly, to a method of providing IP mobility protocol on an SCTP layer.

2. Discussion of the Related Art

3GPP standardizes SAE (System Architecture Evolution) that is new network architecture discriminated from the existing 3^{rd} generation networks for evolution of 3^{rd} generation systems.

FIG. 1 illustrates a configuration of conventional network architecture provided by 3GPP.

Referring to FIG. 1, the 3GPP network architecture includes a UE (User Equipment) 5, an eNB (enhanced Node B) 10, an MME (Mobility Management Anchor) 15, an S-GW (Serving Gateway) 20, and a P-GW (Packet Data Network Gateway) 25.

The UE 5 corresponds to a terminal used by a user, such as a cellular phone, a PDA (Personal Digital Assistant), a notebook computer, a computer, etc. and the eNB 10 corresponds to a base station. The MME 15 is a node for mobility management, the S-GW 20 is a gateway supporting linkage between 3GPP access networks, and the P-GW 25 is a gateway supporting linkage between non-3GPP access networks.

Interfaces are provided for communication among the eNB 10, the MME 15, the P-GW 25 and the S-GW 20. Specifically, X2 interface is provided between eNBs 10, S1-MME interface is provided between the eNB 10 and the MME 15, Si-U interface is provided between the eNB 10 and the S-GW 20, and S5 interface is provided between the S-GW 20 and the P-GW 25. Each interface uses GTP (GPRS Tunneling Protocol) or IP protocol according to control plane and data plane. Here, the X2 interface and the S1 interface are established based on SCTP that is a new IP based transport protocol and the S11 interface is based on GTP-C and the S5 interface is based on GTP or PMIP (Proxy Mobile IP).

When the S5 interface is established based on PMIP, an LMA (Localized Mobility Anchor) which performs signaling for supporting mobility is installed in the P-GW 25 and a MAG (Mobile Access Gateway) is installed in the S-GW 20.

The conventional SAE architecture is expected to be evolved into pure IP based flat architecture, as illustrated in FIG. 2. The SAE in flat architecture includes the UE 5, eNB′ 60 and an aGW 70 and is composed of two stages of eNB′ 60 and aGW 70 to minimize delay in a network. Here, it is expected that the aGW 70 unifies the S-GW 20 and P-GW 25 and the function of the MME 15 is distributed to the aGW 70 and eNB′. In this SAE architecture, the conventional GTP based interfaces not used any more and new interfaces X2′ and S1′ are expected to be based on SCTP.

FIG. 3 illustrates a protocol stack structure of X2′ and S1′ interfaces used in the SAE architecture illustrated in FIG. 2.

The X2′ and S1′ interfaces require stack IP MM for IP mobility management to be added to an IP layer in the basic protocol stack structure for the conventional X2 and S1 interfaces. However, IP mobility management is a kind of signaling fundamentally and a dedicated path for signaling is provided to the conventional SCTP layer, and thus signaling occurs in both the SCTP layer and the IP layer. Accordingly, network related equipment and terminals are designed and implemented in an inefficient manner and unnecessary overhead may generate.

### SUMMARY OF THE INVENTION

It is an object of the present invention to provide a method for providing IP mobility using signaling generated in an SCTP layer to achieve efficient design and construction of network related equipment and terminals in a 3GPP based next generation mobile communication network.

According to an aspect of the present invention, there is provided a method of providing IP mobility comprising: constructing an IP mobility protocol on an SCTP layer of an interface protocol used between an integrated gateway supporting binding a mobile terminal with a different type network and at least one base station and used between base stations; generating a signaling message for binding the mobile terminal with the network according to the IP mobility protocol; embedding at least a part of the signaling message in the SCTP layer to generate an SCTP packet; and transmitting the SCTP packet to request binding of the mobile terminal and the network to be updated or transmit the updating result.

According to the method of providing IP mobility using SCTP signaling in a 3GPP based next generation network according to the present invention, integrated signaling management and simplification of information can be achieved, and thus design and construction of network related equipment and mobile terminals for obtaining IP mobility in mobile terminals and networks can be efficiently performed and unnecessary overhead can be prevented.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates conventional 3GPP based network architecture;

FIG. 2 illustrates IP based flat SAE architecture evolved from the architecture illustrated in FIG. 1;

FIG. 3 illustrates a protocol stack structure of X2′ and S1′ interfaces used in the SAE architecture illustrated in FIG. 2;

FIG. 4 illustrates a protocol stack structure of an interface in a 3GPP communication network according to the present invention;

FIG. 5 illustrates a configuration of a 3GPP communication network according to the present invention to which PMIP is applied as IP mobility protocol of FIG. 4; and

FIGS. 6a, 6b and 6c illustrate formats of data chunk, PBU message and PBA message of SCTP used for binding update in the 3GPP communication network according to the present invention to which PMIP is applied as the IP mobility protocol of FIG. 4.

FIG. 7 illustrates process of generating a signaling message and an SCTP packet in a 3GPP communication network according to the present invention.

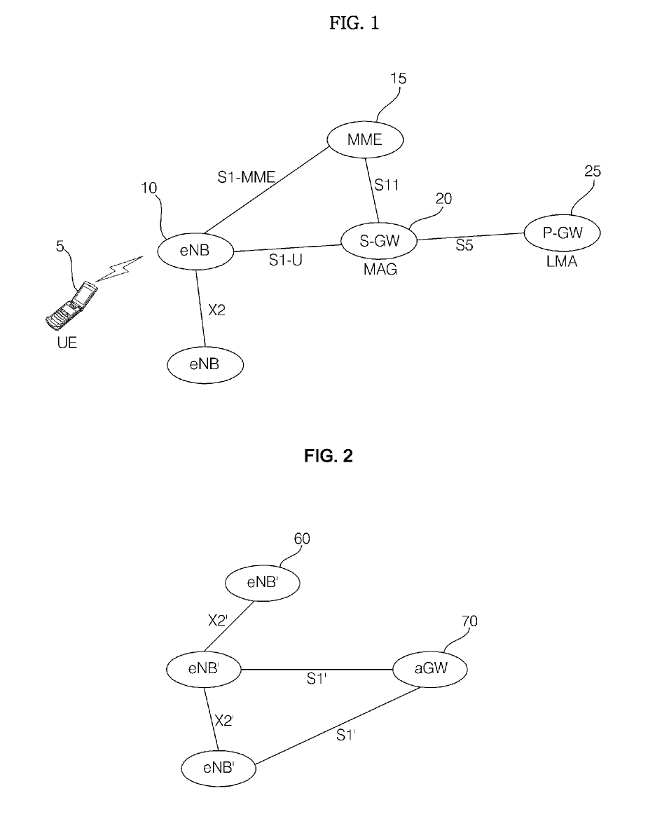

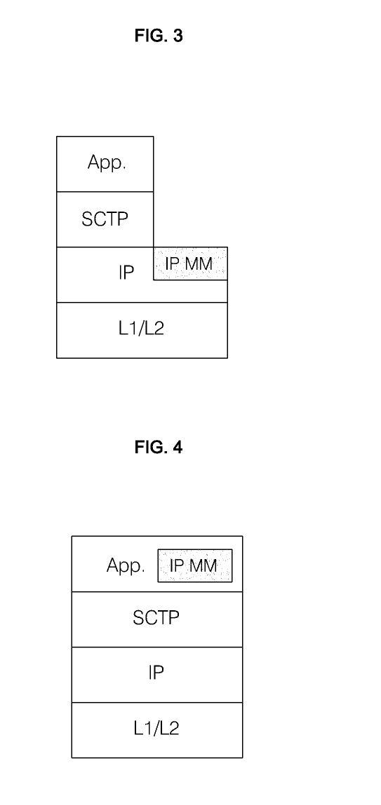

### DETAILED DESCRIPTION OF THE PREFERRED EMBODIMENTS

Hereinafter, embodiments of the present invention will be described below with reference to the accompanying drawings.

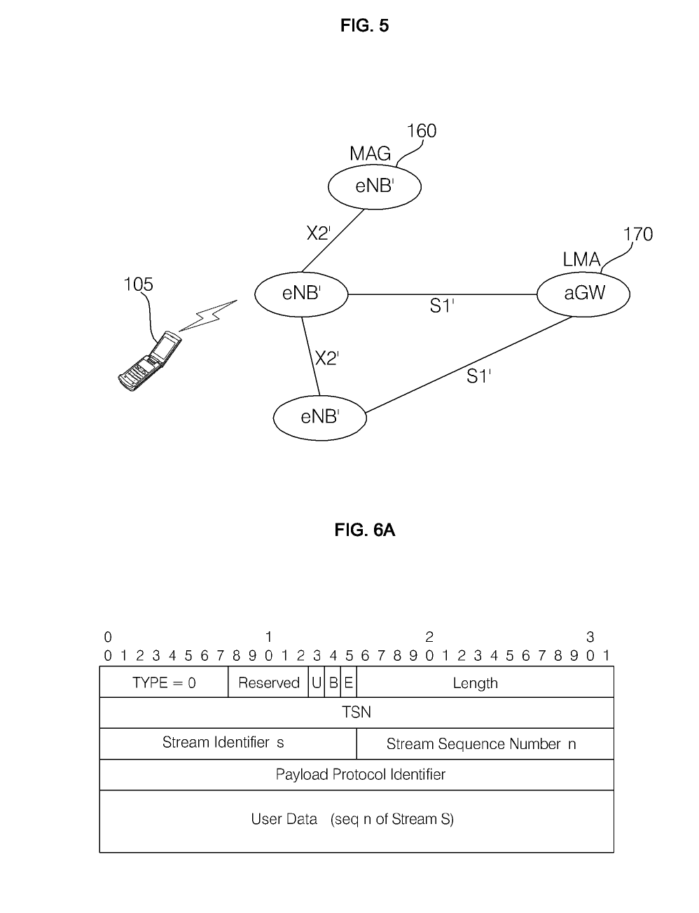

FIG. 4 illustrates a protocol stack structure of an interface in a 3GPP communication network according to the present invention and FIG. 5 illustrates a configuration of a 3GPP communication network according to the present invention to which PMIP is applied as the IP mobility protocol of FIG. 4.

Flat SAE architecture illustrated in FIG. 5 includes a UE 105, an eNB′ 160 and aGW 170 and is composed of two stages of eNB′ 160 and aGW 170 to minimize delay in the network. In this SAE architecture, an interface used between the eBN′ 160 and another eBN′ and an interface used between the eNB′ 160 and aGW 170 are established based on SCTP. These SCTP based interfaces have the protocol stack structure illustrated in FIG. 4. The protocol stack includes an L1/L2 layer corresponding to a physical/link layer, an IP layer corresponding to a network layer, an SCTP layer and an application layer.

Here, the SCTP layer located between the application layer and the IP layer is a transport protocol layer, secures a signaling path between nodes, receives application data from APIs (Application Programming Interfaces) between SCTPs and transmits the application data through an IP network. Each mobile terminal can use multiple IP addresses in a single SCTP session.

The application layer provides data required for signaling between nodes through a message.

IP MM corresponding to an IP mobility protocol is constructed on the SCTP layer as a kind of application. In this case, the IP MM can be easily constructed, construction cost can be reduced and the IP MM can be applied to any IP protocol.

A case where PMIP is applied as the IP mobility protocol to the flat SAE architecture will now be described with reference to FIG. 5.

PMIP is obtained by varying the conventional mobile IP based on a network and currently standardized through IETF (Internet Engineering Task Force) that is a representative Internet standardization organization.

Equipment such as an LMA (Localized Mobility Anchor) and an MAG (Mobile Access Gateway) performing signaling for supporting mobility is included in a PMIP domain. The LAM operates as a local HA (Home Agent) and the MAG is a terminating router performing a mobility management process in substitution for a mobile terminal. The PMIP consumes a small quantity of radio resources because there is no IP mobility related signaling on a wireless section. In addition, the PMIP does not require modification of the existing terminal and a variation in the HA function of the LMA operating as a HA and only needs MAG, and thus it is easy to spread the PMIP.

When the PMIP is applied to evolved SAE, the MAG is installed in the eNB′ 160 corresponding to a base station connected to the UE 105 and the LMA is installed in the aGW 170 corresponding to an integrated gateway. Since the MAG is an IP terminal accessing a terminal in a PMIP structure, installation of the MAG in the eNB′ 160 corresponding to the actual termination of SAE can be considered that the MAG is arranged in an ideal position as compared to the conventional architecture.

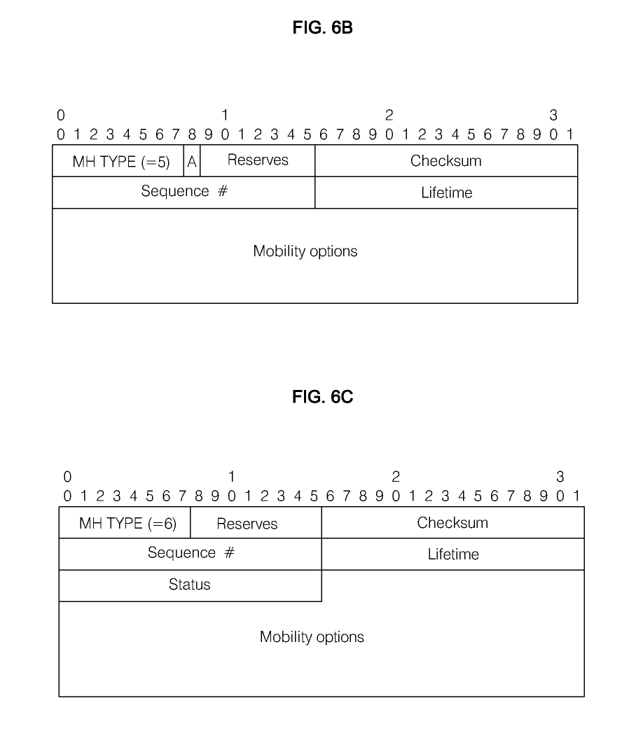

FIGS. 6a, 6b and 6c illustrate formats of data chunk, PBU message and PBA message of SCTP used for binding update in the 3GPP communication network according to the present invention to which PMIP is applied as the IP mobility protocol of FIG. 4.

In general, an SCTP packet is composed of a single header and multiple chunks. There are various kinds of chunks and each chunk includes control information or application data. SCTP performs a signaling process by using these various chunks. In the SAE of the 3GPP communication network according to the present invention, signaling for IP mobility management is performed using data chunks.

The header of the SCTP packet includes a transmitter port number (16 bits), a receiver port number (16 bits), a verification tag (32 bits) and checksum information (32 bits) on the whole packet. The verification tag is allocated to each association and used as a session identifier. A signal SCTP packet may include multiple data and control chunks. A data chunk includes TSN and SSN numbers with respect to the corresponding data chunk in addition to type and length information and is used for error control and flow control.

The format of the data chunk, illustrated in FIG. 6a, is identical to the format prescribed in IETF standard document. In the data chunk message format of the SCTP packet, an IP mobility signaling message is imbedded in a user data region and transmitted. Here, the entire signaling message may be embedded in the user data region and transmitted or a part of the signaling message may be embedded in the user data region and a part of the signaling message may be embedded in another region of the chunk message and transmitted. Here, information on the other region has no relation to the IP mobility signaling message, and thus the information is used without being varied.

When the PMIP is used for IP mobility management, signaling messages required to be transmitted through SCTP include a PBU (Proxy Binding Update) message and a PBA (Proxy Binding Ack) message. Though the PBU message and the PBA message have message formats defined by PMIP standard, the PBU message and the PBA message in the current embodiment of the present invention may not use a mobility header which has been used in IPv6 for IP mobility management in the conventional mobile IPv6 or PMIP because the PBU message and the PBA message in the current embodiment of the present invention perform signaling on the SCTP layer. Accordingly, the PBU message and the PBA message in the current embodiment of the present invention have formats simplifier than the formats of the PBU message and the PBA message used to perform signaling in the conventional IP layer.

The PBU message is included in the user data region of the SCTP packet and includes a mobility head type, A bit, checksum, sequence number, lifetime, mobility option and reserves which are essential information for IP mobility management.

The mobility head type is 8-bit information which defines the type of the mobility header and is represented by 5. The A bit is 1-bit information which requests a binding processing result in the case of binding update. The checksum is 16-bit information for detecting a message transport error, and the sequence number is 16-bit information representing the packet sequence of the PBU message. The lifetime is 16-bit information representing the lifetime of the PBU message and the mobility option is 32*n-bit information. The reserves correspond to 7-bit information reserved for being used later.

Similarly to the PBU message, the PBA message is included in the user data region and includes a mobility head type, checksum, sequence number, lifetime, status, mobility option and reserves.

The mobility head type is 8-bit information defining the type of the mobility header and is represented as 6. The checksum is 16-bit information for detecting a message transport error, and the sequence number is 16-bit information representing the packet sequence of the PBA message. The lifetime is 16-bit information representing the lifetime of the PBA message and the status is 16-bit information representing a binding result. The mobility option is 32*n-bit information and the reserves are 7-bit information reserved for being used later.

The PBU message and the PBA message are included in the user data region of chunk of the SCTP packet as IP MM corresponding to an IP mobility protocol is formed on the SCTP layer, and thus a signaling message is generated only in the SCTP layer. Furthermore, the MAG is installed in the eNB′ 160 and the LMA is installed in the aGW 170, and thus network related equipment is installed in an ideal location.

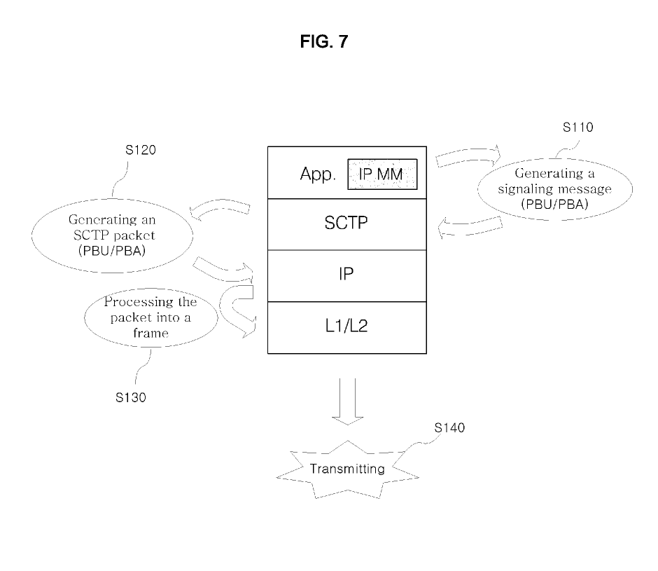

A process of providing IP mobility by using the aforementioned protocol stack in the 3GPP mobile communication network will now be described. FIG. 7 illustrates process of generating a signaling message and an SCTP packet in a 3GPP communication network according to the present invention.

It is assumed that an integrated gateway supporting binding with a different type network and a base station connecting a mobile terminal to the integrated gateway construct SAE in flat architecture, as illustrated in FIG. 5. In this case, protocol stack of an interface used between the integrated gateway and each base station and an interface used between base stations. Here, the protocol stack constructs the IP mobility protocol on the SCTP layer on the basis of SCTP.

Subsequently, in FIG. 7, the IP mobility protocol generates a signaling message in order to bind the mobile terminal and the network or transmit a binding result S110. Here, the signaling message corresponds to a PBU message or a PBA message. The generated PBU message or PBA message is transmitted to the SCTP layer.

The SCTP layer embeds the PBU message or the PBA message in the user data region of a SCTP packet S120. The SCTP packet is processed into a frame while passing through the IP layer and L1/L2 layer S130 and transmitted through the network S140. In this manner, information that requests binding of the mobile terminal and the network or represents the result of binding of the mobile terminal and the network is transmitted.

In the aforementioned IP mobility providing method, the IP mobility protocol is implemented independently of the IP layer in an evolved 3GPP based next generation mobile communication network so that the SCTP layer manages signaling including IP mobility in an integrated manner. This enables efficient mobility management. Furthermore, the IP mobility providing method according to the present invention simplifies information included in the signaling message for IP mobility management as compared to a mobility management method in the IP layer using the mobility header so as to perform IP mobility management easily and simply. This integrated signaling management and information simplification can efficiently design and construct network related equipment and mobile terminal for obtaining IP mobility in the mobile terminal and the network and prevent unnecessary overhead.

While the present invention has been particularly shown and described with reference to exemplary embodiments thereof, it will be understood by those of ordinary skill in the art that various changes in form and details may be made therein without departing from the spirit and scope of the present invention as defined by the following claims.

1-7. (canceled)

8. A network system comprising:
at least one user equipment (UE);
a base station (eNB′) connected to the UE; and
an integrated gateway connected to the base station and providing binding the UE with a different type network,
wherein communication between base stations or between the integrated gateway and the base station is performed using an interface constructed on the basis of SCTP (Stream Control Transmission Protocol).

9. The network system of claim 8, wherein the SCTP based interface includes a physical layer, a link layer, an IP layer, an SCTP layer and an application layer, and a protocol stack implemented as an application with respect to the SCTP layer is applied to an IP mobility protocol for supporting IP mobility.

10. The network system of claim 8, wherein the base station performs a process of managing mobility of the UE to operate as an edge router (MAG), and the integrated gateway carries out the function of an LMA (Localized Mobility Anchor) operating as a local HA (Home Agent).

11. The network system of claim 9, wherein the base station and the integrated gateway embed a signaling message in user data among data chunk of the SCTP and transmit the user data when signaling for supporting mobility of the UE using the SCTP based interface is performed.

12. The network system of claim 11, wherein the base station and the integrated gateway embed at least one of a mobility head type, A bit, checksum, sequence number, lifetime and mobility option, included in a PBU (Proxy Binding Update) message, in the user data and transmit the user data.

13. The network system of claim 11, wherein the base station and the integrated gateway embed at least one of a mobility head type, A bit, checksum, sequence number, lifetime, status and mobility option, included in a PBA (Proxy Binding Ack) message, in the user data and transmit the user data.

14. A method of providing IP mobility, comprising:
generating a signaling message for mobility management in an IP mobility management protocol when communication between base stations or between a base station and an integrated gateway is performed using an interface to which a protocol stack that constructs IP mobility protocol as an application with respect to an SCTP layer is applied;
embedding at least a part of the signaling message in a user data region of data chunk of SCTP to generate an SCTP packet in the SCTP layer; and
transmitting the SCTP packet.
